(19) United States
(12) Patent Application Publication
(10) Pub. No.: US 2005/0230525 A1
(43) Pub. Date: Oct. 20, 2005

(54) Craft with magnetically curved space

(76) Inventor: Von Friedrich C. Paterro, Makati City (PH)

Correspondence Address: OLIFF & BERRIDGE, PLC, P.O. BOX 19928, ALEXANDRIA, VA, 22320, US

(21) Appl. No.: 10/812,018

(22) Filed: Mar. 30, 2004

(51) Int. Cl. B64C 15/02; B64C 29/00

(52) U.S. Cl. 244/23 B; 244/23 C

(57) ABSTRACT

A craft can navigate through a magnetically curved space provided by an electromagnetically charged hull. The hull contains a plurality of sectionalized and independent electromagnetic plates forming portions of the hull exterior wall that can be adaptively energized to have a desired polarity. When combined together, these sectionalized plates can provide an ultra high frequency electromagnetic field of a strength that can magnetically curve the space around the craft. This enables the craft to expeditiously travel through air, space or water. A novel energy generating system using a combination of jet engines and high frequency oscillators is also provided.

### BACKGROUND OF THE INVENTION

1. Field of Invention

This invention relates to a craft that can be propelled through a magnetically curved space. More particularly, the inventive craft has a hull built of electromagnets that generate a controllable electromagnetic field around the craft capable of reducing pressure forces acting on the craft. The electromagnetic field may be powered by use of one or more ultra high frequency oscillators.

2. Description of Related Art

Numerous aircraft and spacecraft have undergone several innovations to increase the power and efficiency of their engines, fuel economy, speed, load capacity, and improved hull designs. However, all flying craft of today are still subjected to nature's ever present atmospheric pressures coupled with the natural effects of gravity, which adversely limit speed, load factor, size and design of hull, and much more, including flyability.

There is a need for an efficient, economical, bigger and faster, safe and versatile flying craft. In particular, there is a need for a craft capable of flying within the earth's atmosphere and beyond in which the effects of atmospheric pressure are reduced to a minimum or perhaps cancelled, allowing the flying craft to fly at extreme speeds without the danger of being torn apart and, in the process, reducing the full effects of Earth's gravitational forces.

There also is a need for a submersible craft capable of handling great pressures acting on the craft, allowing it to travel to great depths or be propelled more efficiently.

There also is a need for an improved energy generation system for such craft.

### SUMMARY OF THE INVENTION

In exemplary embodiments, Applicant has overcome long felt needs for improved flight efficiencies by inventing a novel craft capable of flying within the earth's atmosphere and into the depths of outer space at extreme speeds, or traveling in the depths of the sea, along pathways in a magnetically curved space using a powered hull.

In exemplary embodiments, the craft can be aircraft, spacecraft and sea craft. In a preferred embodiment, the hull is saucer-shaped.

In various exemplary embodiments, the hull includes a plurality of electromagnetic plates to provide the magnetically curved space.

In various exemplary embodiments, the electromagnetic plates extend radially around the hull.

In various exemplary embodiments, the electromagnetic plates are powered by jet engine-driven generators and/or high frequency oscillators.

Very strong electromagnetic fields are generated around the hull of the craft to magnetically curve or bend the space in close proximity to the hull of the craft, such as by pushing all or part of the atmospheric particles or matter contained in this space away from the craft. This decreases the atmospheric drag against the hull, which increases the craft's aerodynamic efficiency and reduces the effect of atmospheric pressure on the craft. This magnetic curving of the space in the vicinity of the craft also shields the craft from excess heat, such as when reentering a planet's atmosphere, by creating a barrier around the hull that deflects such atmospheric particles, so as to preferably keep the hull free from contact with the particles, reducing heat transfer to the craft and reducing pressures acting on the craft. As such, extreme heat is not generated at the hull. Instead, generated heat acts on particles remote from the craft and is pushed away by the radiated field so as to provide a replenishable frontal barrier of such particles.

This phenomenon of curving “space” can be likened to several known or determinable phenomenon. For example, a hovercraft in operation can be observed to have a curved “space” at the immediate area below the craft where an apron is installed around the periphery. This space extends between the craft and the surface of land and/or water and maintains the hovercraft in a levitated position. Similarly, known MAGLEV trains magnetically curve the space between the track and the train to push the train slightly off the ground so as to form an air bearing. That is, the train and track collectively push the space therebetween to achieve slight levitation of the train. Forward propulsion is achieved through manipulated switching of the generated field. Other visible examples of curving of “space” can be found. For example, if you move a strong electromagnetic field towards a body of water, a crater-like opening in the vicinity of the magnetic field displaces a certain volume of water, acting to curve the space in close proximity to the magnetic field. Similarly, this curving of space can be observed if one directs a beam of light towards an ultra-strong electromagnetic field. There will be a slight bending of light as it passes through areas of strong magnetic effect. These examples visualize the effect achieved by aspects of the invention.

The invention similarly pushes away atmospheric particles around its hull continuously or selectively to keep the hull free from contact with such particles to form a curved space where particles in the close vicinity of the craft are pushed or displaced away so as to provide a “space” around the craft that allows increased efficiency through a reduction of aerodynamic drag, as well as a reduced pressure force acting on the hull.

In other exemplary embodiments, Applicant has overcome long felt needs for improved navigation efficiencies by providing upper and lower hull surfaces formed from electromagnetic walls that can be sectionalized and separately adjusted to a desired polarity. For example, when both upper and lower hull surfaces are adjusted to a same polarity, a magnetic levitation effect can be realized, similar to that used in Japan's MAGLEV trains, to supplement the craft's vertical thrust and achieve an efficient hover operation. In another example, the polarity can be selected to be the same as the earth's magnetic field (i.e., the Earth's closest hemispheric field) so as to provide a supplemental repulsion force that can be used to propel the craft, particularly once it has left Earth's atmosphere. This magnetic field control can also be used to adaptively adjust the electromagnetic radiation profile emitting from the craft's hull for various purposes.

Propulsion for the craft may come from any of several sources, including steam power created by nuclear energy, such as disclosed in Applicant's U.S. Pat. No. 6,290,184 entitled Flying Craft With Air and Water Propulsion System, one or more quantum jet turbine engines as disclosed in Applicant's co-pending U.S. patent application Ser. No. ______ (Attorney Docket 102901) filed concurrently herewith, and/or other conventional propulsion sources, such as jets or rockets. Any of the above may be supplemented with a compound exhaust system, such as disclosed in Applicant's U.S. Pat. No. 6,367,739, which increases the efficiency of the propulsion source. The disclosures of U.S. Pat. No. 6,290,184, U.S. Pat. No. 6,367,739, and co-pending U.S. patent application Ser. No. ______ (Attorney Docket 102901) are hereby incorporated herein by reference in their entireties.

The craft is preferably double-walled. The inner wall is much thinner than the outer wall and made up of strong composite materials, such as alloys of iron, cobalt, aluminum, nickel and copper. Similarly, the outer wall is also made up of strong composite materials, preferably of the same composition. However, the outer wall is much thicker and in sectionalized plates. The walls are joined by a core that is powered to generate an electromagnetic force.

The hull of the inventive craft is thus a very strong electromagnet, which can be amplified to radiate an ultra high frequency magnetic field around it. The field can be powered by a plurality of, preferably 33, inboard independent high frequency field generators that are directly coupled to multiple, preferably 11, quantum jet turbine engines, each preferably with three, independent high frequency generators each. The quantum jet engines use the resultant exhaust gas flow to drive the inboard generators to provide an electrical power source, rather than serving as a propulsion source.

The amount of electricity available to meet the electrical needs in the production of the ultra high frequency magnetic field may be augmented by electricity produced by high frequency oscillators (cavity resonators) in vacuum. Such oscillators may be installed in between deep lower circular cavities of the bottom side of the outer wall sectionalized plates. Such oscillators may also take the form of oversized ring-shaped triode high frequency oscillators suitably installed, such as three located at a periphery of the bottom of a cockpit and two located at a periphery of a top of an exhaust system.

When the craft is in operation, an ultra high frequency magnetic field will be radiated by its hull, causing atmospheric particles in the space in the vicinity of the hull to curve or bend. This curved space allows the craft to be propelled expeditiously along the pathways of its magnetically curved space at extreme speeds, greatly reducing or canceling the effects of atmospheric pressures against the craft's hull and increasing its inertia. This can produce beneficial effects against the pull of gravity, allowing the spaceship to perform greatly beyond the allowable limits of conventional craft. With this invention's capability of curving magnetically the atmospheric particles immediately around the craft, the craft's maneuverability can thus be improved by effective reduction of aerodynamic drag.

By further using an efficient compound exhaust system, such as the one described in Applicant's U.S. Pat. No. 6,367,739, the inventive craft is able to greatly improve fuel economy, load capacity and other beneficial factors that limit current production craft.

During outer space travel, the inventive craft may deactivate all secondary high frequency generators installed in the lower perimeters of the propulsion system in order to fully use all expended superheated steam for propulsion only, making every drop of fuel more efficiently used, and allowing the spaceship to cover wide areas for every gallon of fuel. The inventive craft may also use super-chilled air and water (H₂O) as a propulsion source when operating within the earth's atmosphere.

During sea craft use, the inventive craft is capable of operating at substantial depths due to the electromagnetic field providing a magnetically curved space that shield's and protects the craft's hull from the full effect of the extreme pressures that would otherwise act on the craft. This allows the craft to operate at depths otherwise unobtainable.

### BRIEF DESCRIPTION OF THE DRAWINGS

The invention will be described with reference to the following drawings wherein:

FIG. 1 shows a side view of a saucer-shaped craft according to an exemplary embodiment of the invention;

FIG. 2 shows an underside of the craft of FIG. 1 and placement of individual jet engines and directional control nozzles according to exemplary aspects of the invention;

FIG. 3 shows an exemplary quantum jet engine according to embodiments of the invention;

FIG. 4 shows an exemplary passenger version of a flying craft showing a cockpit;

FIGS. 5A-C show a partial cross-sectional bottom view of a sectionalized part of the outer wall of the hull of the craft of FIG. 1, a partial perspective cut-away view of the plates making up substantial portions of the hull of the FIG. 1 craft, and a cross-sectional bottom view of the outer wall of the FIG. 1 craft showing optional oscillators provided in deep cavities between adjacent plates;

FIG. 6 shows a cross-sectional view of a triode high frequency oscillator according to exemplary embodiments of the invention; and

FIG. 7 shows an alternative exemplary exhaust design, in which compressors are provided to recycle at least part of the exhaust gases for recirculation.

### DETAILED DESCRIPTION OF PREFERRED EMBODIMENTS

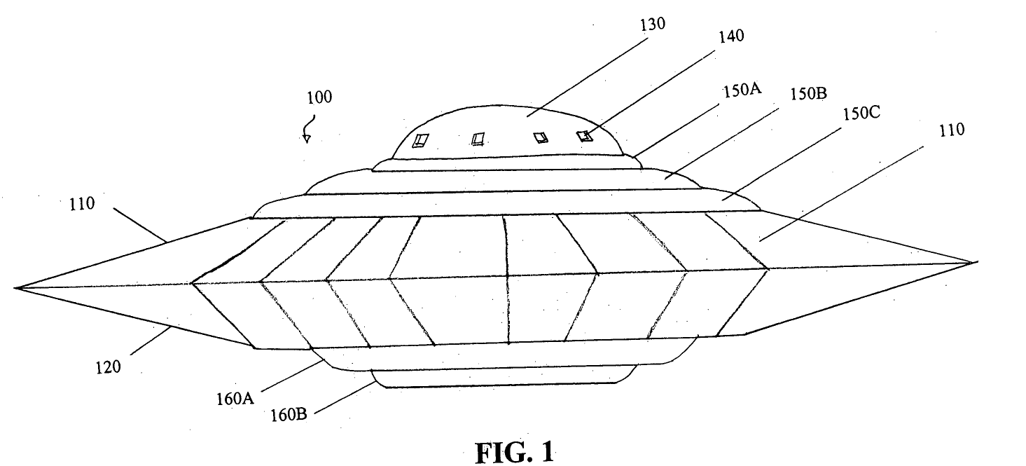

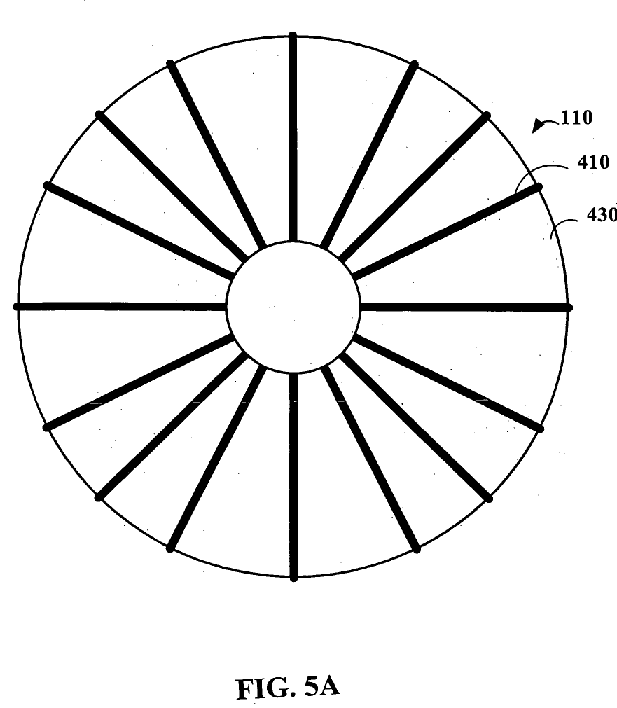

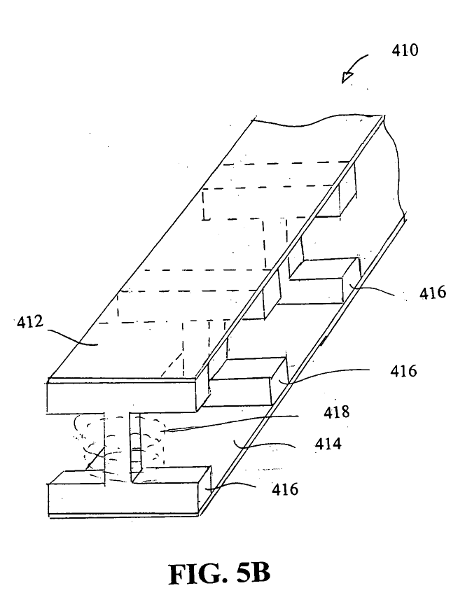

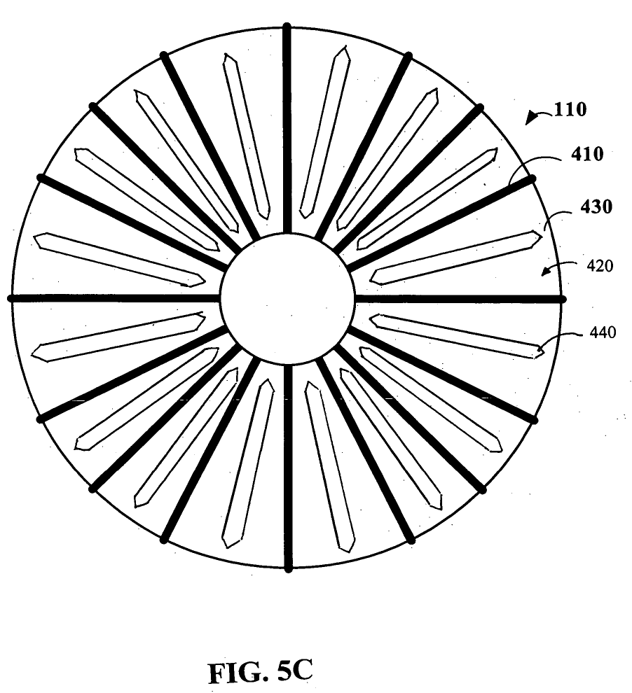

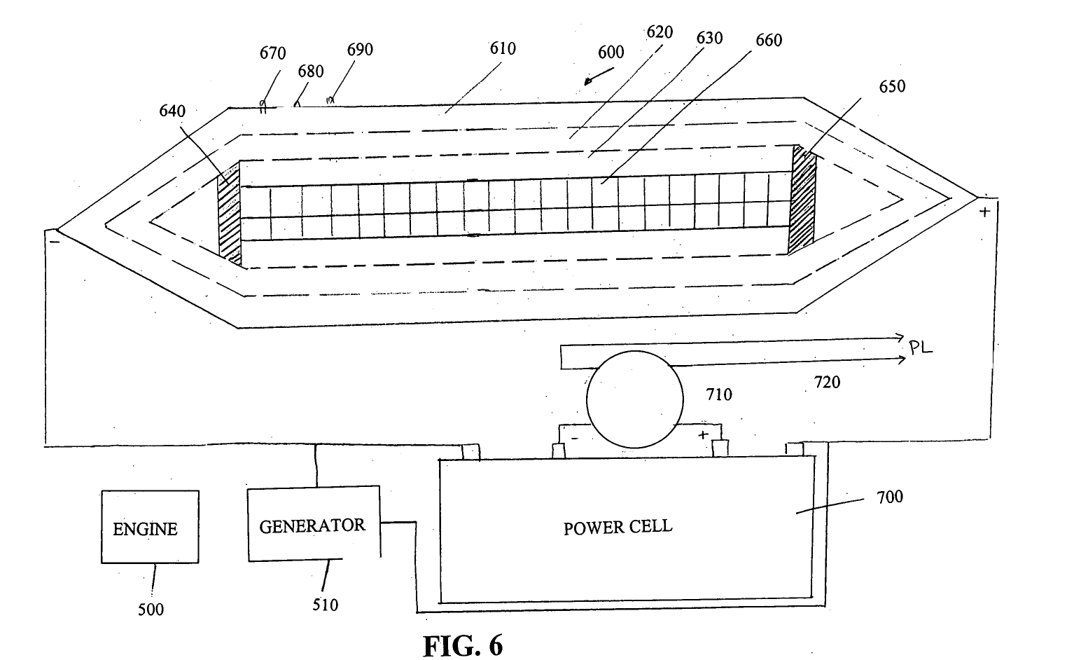

The invention will be described with reference to FIGS. 1-7, which show an exemplary saucer-shaped craft design. However, the shape and configuration of the hull is not limited to such designs, but may encompass other hull shapes. FIG. 1 shows a craft 100 that is saucer-shaped including top and bottom hull halves 110, 120, and cockpit 130 with one or more viewing windows 140, which may be automatically opened and closed. External high frequency oscillators 150A-C and 160A-B are also shown, with three spaced oscillators 150A-C being provided on the top hull 110 around cockpit 130 and two oscillators 160A-B being provided on the bottom hull 120 around the craft's exhaust system. The high frequency oscillators 150, 160 may be formed from tri-cylindrical triode tubes, often called cavity resonators, as better described below with reference to FIG. 6. The high frequency oscillators 150, 160 supplement the production of electricity for the craft and empower the hull 110, 120 to radiate an ultra high frequency magnetic field. A plurality of electromagnetic plates 410 may be provided along portions of the hull exterior as better described below with reference to FIG. 5. In various exemplary embodiments, the craft can serve as a flying craft.

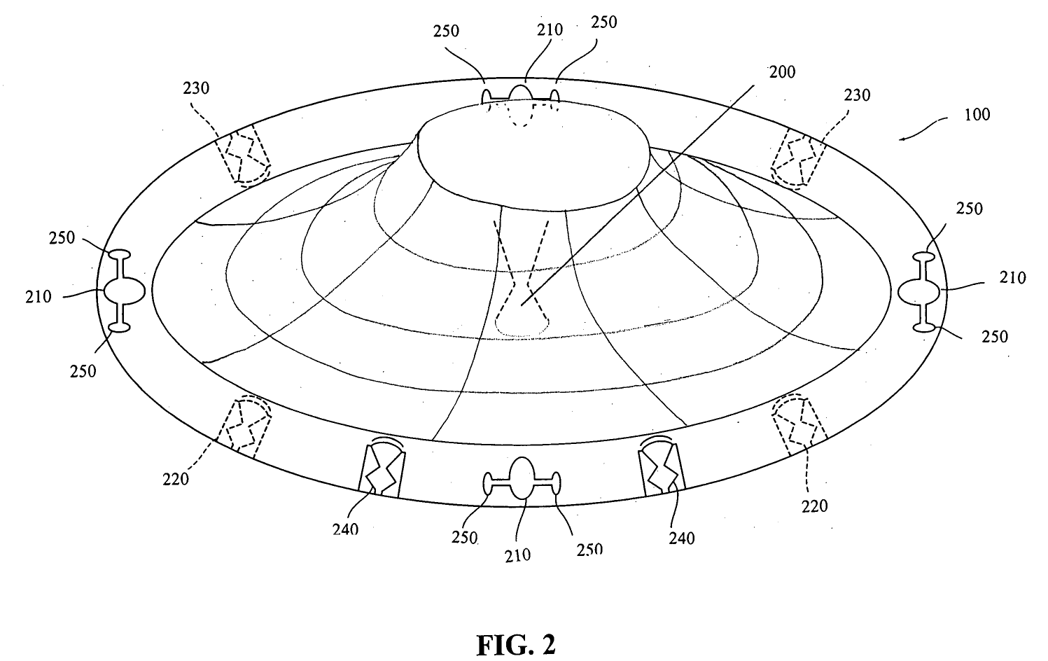

FIG. 2 shows exemplary placement of propulsion engines and navigation control equipment used in connection with operation of the craft. FIG. 2 is a skeletal view of the inventive craft of FIG. 1. In particular, multiple combustion power plants, such as quantum jet turbine engines, are spaced about the hull, each with an assigned task. This includes central engine 200, fixed vertical engines 210, two sets of reversible vertical and forward thrust engines 220, two sets of reversible vertical and backward thrust engines 230, two sets of fixed quantum jet turbine engines 240 tasked to produce forward thrust for propulsion, and various directional control nozzles 250 tasked to work as navigational guides. Additional directional control nozzles may be provided, such as at the lower rim of cockpit 130 (unshown).

The main and/or central engine 200 is preferably an octa-quantum jet propulsion system having eight individual engines sealed inside one compound exhaust system tasked to function as a fixed central vertical quantum jet turbine engine. Four permanent (fixed) vertical engines 210, preferably four quantum engine units each containing four individual quantum jet turbine engines serviced by an independent compound exhaust system, are spaced around the periphery of the craft and tasked to produce additional vertical lifting power. The reversible engines 220, 230 are tasked to work as reversible vertical/forward thrust engines (220) or reversible vertical/backward thrust engines (230). That is, engines 220, 230 are pivotal through about 90° of rotation to adjust the direction of thrust. Engines 230 in addition to providing backward thrust for a reverse flight configuration, also serve as a brake mechanism used to slow the craft when operating with forward speed.

Exemplary craft mobility will now be discussed, referring back to the various Figures. For take-off from Earth, the two (2) reversible vertical and forward thrust engines 220 can be set for vertical work. Likewise, the two (2) reversible vertical and backward thrust engines 230 can be set for vertical work. The four (4) reversible engines will augment the five (5) permanent vertical engines (main vertical engine 200 and four fixed vertical engines 210) to make nine (9) total vertical engines to provide adequate take-off propulsion. Such engines can also be used for landing.

Upon take-off, all the nine (9) vertical engines will be set at full power to raise the craft 100 to its desired altitude for horizontal flight. Upon reaching this altitude, the four (4) reversible engines 220, 230 can be idled while the five (5) vertical engines 200, 210 increase power to maintain a hover configuration. At this time, the four reversible engines 220, 230 can be returned to a designated position. In the process, the reversible vertical and backward thrust engines 230 can be shut off while the two reversible vertical and forward thrust engines 220 can be set for forward thrust together with the fixed forward thrust engines 240. At this time, the engines 220 will be oriented to face the forward movement direction. Thereafter, the four (4) engines 210 can be fully synchronized and powered accordingly to propel the craft with a desired flight profile and speed in a horizontal flight configuration. At this time, the high intensity electromagnetic fields may be generated by the various sectionalized plates 410 (FIG. 1). Thus will result in magnetic curving of the space immediately around the hull, thereby creating a magnetically curved pathway wherein the craft can travel at extreme speeds and be spared from the adverse effects of strong atmospheric pressure.

To bank left, the craft's fixed right vertical engine 210 will increase power while the fixed left vertical engine 210 will decrease power. To bank right, the opposite can occur. Righting to a horizontal position can be achieved by returning the low side engine to the power level of the opposite high side engine. To dive, the front vertical engine 210 will decrease in power as compared to the back vertical engines 210 and/or 240. Then, while diving, the front vertical engine 210 can be powered just enough to sustain a desired angle of dive. To climb, the front vertical engine 210 can be increased in power while the power of the back vertical engine 210 is decreased, and the craft will climb with its front vertical engine 210 sustaining power enough to support the desired angle of climb. To return to normal, the front vertical engine 210 can be decreased in power, while the back vertical engine 210 is increased in power.

For increased mobility, the craft can be equipped with multiple directional control nozzles, such as nozzles 250 shown in FIG. 2. The directional control nozzles are installed around the hull and control the direction of the spaceship while in flight by guiding it to whichever direction is desired.

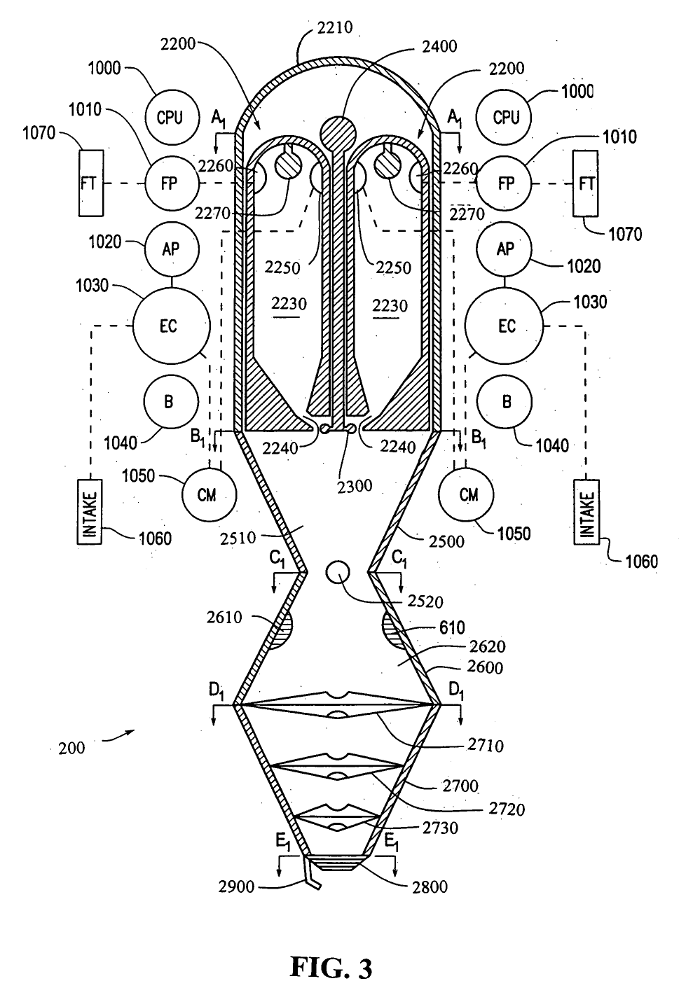

An exemplary embodiment of a quantum jet engine is illustrated in FIG. 3, which shows multiple quantum jet turbines housed in a common air-tight sealed exhaust system. The jet engines are preferably sized and symmetrically arranged within the exhaust system as shown, so as to provide a commonly and centrally oriented gas exhaust flow path.

The jet engines do not take in air directly from the atmosphere as in conventional jet engines. Rather, air or oxygen are received through sealed feed lines from efficient and independent on-board air compressors on the craft or externally provided for the engine. The air compressors may receive and transfer to the quantum jet engines air/oxygen received from either a remote storage tank or a remote air intake separate from the sealed jet turbine engines. The incoming air may be filtered as desired. This puts an end to the numerous problems associated with conventional jet engine designs that are prone to sucking large objects into their jet engine intakes.

In particular, FIG. 3 shows a quantum jet turbine engine system 200 including multiple separate quantum jet engines 2200 housed within a single, common sealed exhaust system, preferably made up of sections A1, B1, C1, D1 and E1. Each quantum jet engine 2200 is housed in section Al of the exhaust system and includes an outer casing 2210 having a sealed, airtight top and converging lower walls 2220 defining a combustion chamber 2230 therebetween. Each quantum jet engine 2200 further includes a combustion exit orifice 2240.

Within each combustion chamber 2230 are located one or more air nozzles 2250. Air nozzles 2250 are operably connected to an electric air compressor 1030 through a suitable airtight, sealed feed line (unshown). Flow from the compressor 1030 to air nozzles 2250 may be enhanced by air pump 1020 provided in-line between compressor 1030 and air nozzles 2250. Electric air compressors 1030 may receive air/oxygen from a suitable remote source, such as an on-board storage tank or through shown intake 1060, which is in communication with the atmosphere but is provided remote from the jet engines 2200. Suitable filtering may be provided at or between the intake 1060 and electric compressors 1030 to prevent large objects from entering the system.

Also within each combustion chamber 2230 are located one or more fuel nozzles 2260. Fuel nozzles 2260 are operably connected to an on-board fuel storage tank 1070 through a suitable airtight, sealed feedline (unshown). Flow from the tank 1070 may be enhanced by a fuel pump 1010 provided in-line between the tank 1070 and fuel nozzles 2260.

A spark generator 2270 is also provided within the combustion chamber 2230 of each jet engine 2200. Spark generators 2270 may receive electrical power from one or more on-board batteries 1040, or from generator 2400 provided within the common exhaust system. Generator 2400 may be operably connected through a shaft or other structure to a turbine 2300 having one or more turbine blades placed in the exit path of the combustion exit orifices 2240 as shown. Upon generation of combustion gases exiting the various jet engines 2200 through orifices 2240, rotation of turbine 2300 will occur, which can be used with known and conventional structure to generate electrical energy from generator 2400. Electrical output from generator 2400 may be electrically connected to batteries 1040 for recharging purposes and/or may be used to power various auxiliary devices, such as the hull's electromagnetic plates, preferably by providing power to a common power grid. Other accessories, such as processor 1000, fuel pump 1010, air pump 1020, electric air compressors 1030, and cooling mechanisms 1050 may also be powered by this electrical output.

During operation, quantum jet turbine engines 2200 are started by activating battery power to both the air and fuel pumps 1020, 1010, respectively. Upon reaching suitable operating pressures, a desired amount of air and fuel will be fed to combustion chambers 2230 while spark generators 2270 are electrically activated. Upon initial ignition, processor 1000 can cut off battery current and simultaneously activate the main electric air compressors 1030, while simultaneously activating the fuel and air pumps and other electrical devices by way of current flowing from generator 2400, which is suitably sized to power all required electrical devices.

The inventive quantum jet turbine system is extremely versatile and adaptable to a multitude of possible fuel sources, such as high grade kerosene, high grade diesel fuel, alcohol, or other solid or liquid fossil fuels. It can also operate on a mixture, such as a 70/30 mix of high grade (distilled) alcohol (C₂H₆O, C₂H₅0H, or CH₃OH) plus distilled purified water (H₂O), which results in an efficient, safe and more environmentally friendly fuel that can be smokeless. Other applications may use a 50/50 mixture of alcohol and water, or may use 100% purified water alone (or with superchilled air) as a steam-powered version, that are completely environmentally friendly solutions that do not rely on fossil fuels.

For example, in one exemplary design, it is possible to use a fuel mix of 70% high grade alcohol (C₂H₆O) plus 30% distilled water (H₂O), considering the physical properties of both compounds wherein alcohol has a low boiling point of about 375° F. (197.2° C.) and distilled water has a boiling point of 212° F. (100° C.). Both compounds should be distilled to make them more efficient in achieving faster conversion from liquid to gaseous state, due to the pure substances having no other minerals or deposits that are not combustible and could solidify and produce nozzle clogging or contamination to the combustion chamber walls 2210, which can cause maintenance problems.

Most alcohols and water mix well. As such, the combination is suitable as a mixture. When this fuel mix is fed to the combustion chambers 2230 and ignited by spark generators 2270, the alcohol portion of the mix burns easily, raising the temperature inside the combustion chambers 2230 to over 100° C. in a very short time. Thus, expanded gases from the burnt alcohol will start moving at extreme speeds. Likewise, the water portion of the mix (30%) will be rapidly heated and boiled into steam at 100° C., at which time it also expands and moves at great speeds through the combustion chambers 2230 towards exit orifices 2240 where the accelerating and expanding gases pass across turbine 2300. This generates electrical power from generator 2400 used to continue operation of all electrical accessories.

The exiting combustion gases enter an upper gas reaction area 2510 formed from converging walls 2500 of exhaust section B1. In this section, the exiting gases further expand and develop high pressure and temperature, ever continuously expanding and rushing toward automatic adjustable gas entry point 2520 where the exiting gases then enter a lower gas reaction area 2620 formed by diverging walls 2600 of exhaust section C1. In lower gas reaction area 2620, the exiting gases further increase in pressure and temperature and enter the first stage of a multiple stage compound exhaust system 2700 provided at section D1 of the exhaust system. As shown, there are three stages formed by stage sections 2710, 2720 and 2730. Continued flow paths of the exiting gases develop multiple action and reaction forces, acting to further extract kinetic force from the gases and further providing thrust force to propel the jet and associated craft upward. A suitable exemplary multiple stage compound exhaust system is the 3-stage compound exhaust system disclosed in U.S. Pat. No. 6,367,739, the subject matter of which is hereby incorporated herein by reference in its entirety.

Upon exiting from compound exhaust system 2700, exiting combustion gases are received by thrust vector nozzle 2800, which can be suitably controlled to direct the exiting gases in a desired thrust vector that may be other than in axial alignment with the exhaust system. Owing to the sealed intake structure, such a jet engine will operate with reduced sound level than that typically found on conventional jet engines that include a large open-mouth intake system. If additional sound reducing properties are desired, a conventional sound cancellation device 2900 can be installed to the end of the exhaust as known in the art. Additional details on the operation of the quantum jet engines can be found in Applicant's incorporated co-pending U.S. patent application Ser. No. ______ (Attorney Docket 102901).

Although shown above to describe operation of main quantum jet turbine engine system 200, the other jet turbine engines 210, 220, 230 and 240 can have the same general quantum jet engine configuration, albeit preferably smaller in scale.

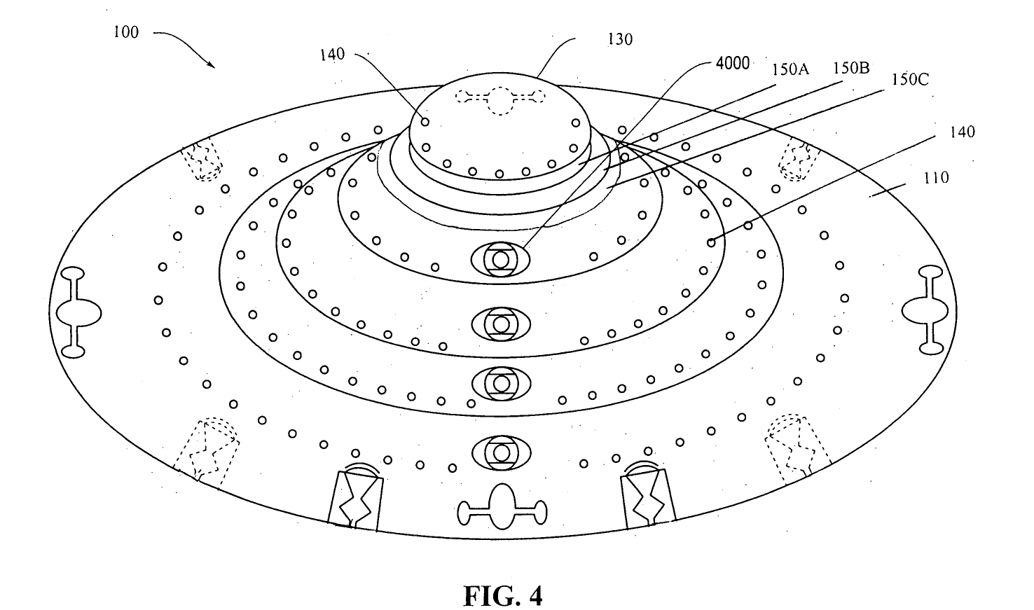

FIG. 4 illustrates an exemplary passenger craft according to the invention showing cockpit 130, wide automatic windows 140 provided not only around cockpit 130, but also spaced around upper hull 110, and wide automatic doors 310. The design features of this craft make it very versatile in that it can be applied to all military and civilian models, specifically military craft, bulk cargo carriers, fire fighters, passenger flying craft, tankers, transporters, space shuttles, and others. It also has applications other than flying craft, such as a submersible craft capable of navigating at great depths in the sea.

FIGS. 5A-C illustrate the preferred double-walled hull structure. FIG. 5A is a cross-sectional bottom view of a sectionalized part of upper hull 110, with the inner hull wall removed, showing the internal radial structure of the electromagnetic plates 410. Lower hull 120 is similar, but reversed. FIG. 5B illustrates a partial perspective cut-away view of the electromagnetic plates 410 making up a portion of the hull. FIG. 5C is a cross-sectional bottom view of an assembled outer hull wall, with the inner hull wall missing, to show the radial internal structure of the electromagnetic plates 410 and optional high frequency oscillators 440 provided in deep spaces 420 between adjacent radial extending plates 410.

Upper hull 110, which extends around cockpit 130, includes a series of sectionalized electromagnetic plates 410, shown in exemplary radial form, and conventional wall surfaces 430 provided between adjacent plates. The combination of conventional wall surfaces and plates 410 form the outer hull of the hull 110. As better shown in FIG. 5B, each electromagnetic plate 410 includes an outer wall 412, an inner wall 414, and magnetic cores 416, each with a plurality of coil windings 418 wrapped around it.

The illustrative electromagnetic sectionalized plates 410 can come in many sizes and/or shapes to accommodate this. For example, each could be 1 foot wide by 200 feet long or 1 meter wide by 200 meters long, and extend radially from the periphery of the upper cockpit to the lower edge of the craft hull. Alternatively, the sectionalized plates could be installed perpendicularly or peripherally around the upper and lower hull sections.

In an exemplary embodiment, the consolidated sectionalized upper walls together comprise a large amount of the surface area of the upper hull, such as about fifty percent (50%). However, when higher electromagnetic fields are generated, the surface area can be reduced. It is also desirable to have an outer peripheral rim of the upper and lower hulls 110, 120 taper, so as to lock or mate with a similar outer wall on the corresponding mating hull. This will make the hull airtight.

The double-walled hull structure of inner and outer plate walls 414, 412 is preferably made of a strong composite material with alloys of iron, cobalt, aluminum, nickel, and/or copper so as to provide a good electromagnetic property. Walls 430 may be made of similar materials. Plate walls 412, 414 may be riveted, welded or otherwise fixed to cores 416 as known in the art.

The electromagnetic cores 416 are made up of strong composite materials, preferably with alloys of iron and nickel (PERMALOY), which are suitable for use in generation of a high electromagnetic field. The cores 416 preferably are I-shaped, with a large number of turns of high frequency, insulated electro-wire wrapped around each “I” continuously from end to end. The cores preferably have a depth of about two (2) feet or more from top to bottom, and are connected to a power source, such as the power grid in FIG. 6, preferably in parallel, for better and failsafe performance. This minimizes the possibility of malfunctions that may occur if plates 410 are connected to a power source in series. By making the cores 416 have a depth of about 2 feet or more, deep cavities 420 (FIG. 5C) can be provided between the upper and lower walls, which can house one or more oscillators (cavity resonators) 440 as shown in FIG. 5C. Such cavities may be insulated or the like to protect the oscillators from the coil wires 418 or the like.

The highly magnetized inner wall 414 is much thinner and preferably made up of much larger metal plates. The highly magnetized outer wall 412 is preferably much thicker and made up of sectionalized metal plates with the deep cavities 420. That is, oscillators 440 can be provided in the spaces defined between the inner and outer walls 414, 412 and adjacent plate sections 410.

Coils 418 are wrapped around cores 416 with countless turns of heavy duty electrical wire to produce strong and high frequency electromagnets by infusing high electrical energy in the complete circuit. The size and number of sectionalized electromagnetic plates around the upper and lower hulls 110, 120 should be powerful enough to enable the spaceship to radiate an ultra high frequency magnetic field around its hull and, in the process, magnetically curve the atmospheric particles in the area immediately around the craft. This will allow the craft to navigate expeditiously in any direction, greatly minimizing, if not totally canceling, the atmospheric pressure and drag acting on its hull during extreme speeds.

Likewise, the inner wall radiates the same high frequency magnetic field around its perimeter, and in the process magnetically curves the space around it. This is envisioned to counter weightlessness, allowing passengers, equipment, cargo and other movable objects to remain upright and firm during extreme speeds and difficult maneuvers.

All of the magnetic plates around the entire hull can be interconnected and operated independently or as a whole. For example, circuit terminals can be manipulated to engage or disengage a plate from power or reverse its polarity. Moreover, the sectionalized plates 410 are preferably independently isolated and insulated from each other.

All of the sectionalized plates may be controlled by complex multi-circuit panels run by efficient inboard computers, which direct all the necessary applications required, such as the electrical energy needed by the individual sectionalized metal plates to change or maintain each plate's polarity (“S” and “N” magnetic poles), either singly, by pairs or for an entire section of any side of the hull. For example, the hull can radiate a high frequency magnetic field with a desired “S” magnetic pole or an “N” magnetic pole at any given time using the isolated and insulated sectionalized metal plates, either singly, by pairs or by section. Polarity can be changed by introducing a large electrical current flowing from a positive terminal to a negative terminal. Polarity can be switched back by introducing a large electrical current flowing from the negative terminal to the positive terminal.

This, for example, allows the craft to intelligently decide at anytime and place when to shift to “S” pole magnetic field and “N” pole magnetic field, considering that the Earth is a giant magnet with a strong magnetic field around it and lines of force running between the poles that curve high into the atmosphere, even where the pull of gravity is weak. Earth's huge magnetic field differs in intensity in direct proportion to its distance from either the south pole or the north pole. Because same polarity magnets repel, this craft, while in operation around the earth's atmosphere, can have the capacity to radiate an ultra high intensity magnetic field of the same polarity, yet much stronger, than Earth's magnetic pole prevalent in a particular area. This may be beneficial to help propel the craft outward, particularly when gravitational forces have been overcome or are weak.

Although the craft's capabilities to interplay with the Earth's great magnetic field do not in totality remove the effects of the Earth's pull of gravity, the sum total of the repulsion forces of all of the craft's electromagnetic plates acted on by the Earth's magnetic field can constitute a great effect in the flyability of the craft.

The various sectionalized plates 410 can also be interchanged at will in various combinations (of “N” or “S” poles or combinations) or singly to selectively magnetically curve the space around specific portions of the hull and reduce the effects of atmospheric pressure against it. This produces unlimited advantages in the craft's ability to fly expeditiously beyond a conventional aircraft. This can be used to radiate an ultra high intensity magnetic field with an “S” magnetic pole on the entire lower section of the outer-wall and, likewise, radiate an ultra high intensity magnetic field on the upper section of the outer wall with an “N” magnetic pole or vice versa, if needed. For example, when both upper and lower hull plates 410 are adjusted to a same polarity, such as an “S” magnetic pole, a magnetic levitation effect can be realized, similar to that used in Japan's MAGLEV trains, to supplement the craft's vertical thrust and achieve an efficient hover operation. Also, when reentering into Earth's atmosphere, the lower plates can be activated to provide a forward magnetic shield that protects the front surfaces of the craft from the intense heat and pressure of reentry by the magnetically curved space it creates.

FIG. 6 illustrates an exemplary electrical power source for the craft. The electrical requirements of the spaceship will be met by two (2) sources:
1. Electricity generated by a series of engines 500, preferably eleven (11) quadro quantum jet turbine engines, each equipped to power three (3) inboard high frequency generators 510, for a total of thirty-three (33) generators 510.
2. Electricity generated by a series of vacuum high frequency oscillators 600, preferably of the modified KLYSTRON type, which can take the form of ring shaped oscillators such as oscillators 150A-C in FIG. 1, oscillators 160A-B in FIG. 1 or the elongated oscillators 440 in FIG. 5C. However, any form of oscillator can be used.

The engines 500 are preferably of the type described in FIG. 3, although any engine source could be used to power generators 510. Although shown as inboard, generators 510 could also be external and of conventional types. Power generated by generators 510 can be fed to a central power grid, such as central ultra high frequency power cell 700 shown, through electrical lines. The engines 500 and generators 510 are suitably located within the confines of the flying craft.

In preferred embodiments, the main thrust engine 200 and other thrust engines 210, 220, 230 and 240 may each have one or more generators to assist in electricity generation (in addition to the 33 dedicated engines and generators 500, 510). At start up, one of the generators may power the main engine 200. However, once powered, secondary generators may be activated to take over all the electrical requirements of the flying craft and all battery power can be cut off. At this stage, the remaining thrust engines 210, 220, 230 and 240 may be started using power generated by the generators. All excess power will be provided to the central power cell 700. Power from power cell 700 will then energize all or various combinations of the sectionalized electromagnetic plates to produce a desired ultra high intensity magnetic field around the craft that will magnetically curve the space around the spaceship.

As shown, the oscillator 600 uses three (3) hollow tubular cavities made up of one (1) external hollow zinc tube 610 with two (2) inner independent hollow copper tubes 620 and 630. Electrons oscillate in each of the three (3) tubes at a rate of more than one (1) billion cycles per second, and are moved by a magnet (unshown) or other source to make an electric current.

Also shown are a cathode plate 640 which is negatively charged, and an anode plate 650 which is positively charged. A grid 660 is provided between the plates through which electrons oscillate from the cathode plate 640 to the anode plate 650. Direct current is supplied to the oscillator 600 and alternating current is produced. Although magnetism is preferred because of its availability on board, other sources of energy can be used to move electrons in order to produce an electric current, including friction, pressure, chemical action and light.

Three (3) suction air tubes 670, 680 and 690 pump out the air inside the oscillator 600, preferably to keep it in total vacuum. Power generated by oscillator 600 is fed to the power cell 700 by electrical lines. Power from power cell 700 can be amplified by a high frequency transistorized power amplifier 710, which can feed power to a power line 720 that forms a power grid that provides power to all accessory devices of the flying craft.

The first tube 610 is zinc and electrons from the atmosphere travel into this tube. Because zinc gives up electrons freely relative to copper, the electrons will pass from the zinc tube to the copper tubes 620, 630, which become negatively charged. Electrons are particles of negative electricity, and are found in the atmosphere, within any object or on its surface, and also in a vacuum. In a vacuum, it is rather simple to produce a current of electrons. The mere heating of a filament in vacuum can produce a swarm of electrons. As they “boil off” from the filament, they can be induced to flow across the vacuum toward a positive connector from a power cell connected to the filament. Thus, the positive connector at some distance away will lure the electrons toward itself because positive charges attract negative charges.

All the high frequency oscillators (HFO) of this invention will be inter-connected to each other, such that the anode plate 640 of one oscillator 600 is connected to the grid 660 of a second one, and so on and so forth (in series), yielding much greater amplification and delivering the sum total of all their electric current to power cell 700.

With the capacity of this invention to radiate an ultra high frequency magnetic field, radar could become obsolete, for it cannot penetrate through the magnetic field and give away the signature of the spaceship. It could thus serve as a “stealth” flying craft. Because of its ability to change its field generation at will, it can also rapidly change any magnetic profile it does give off.

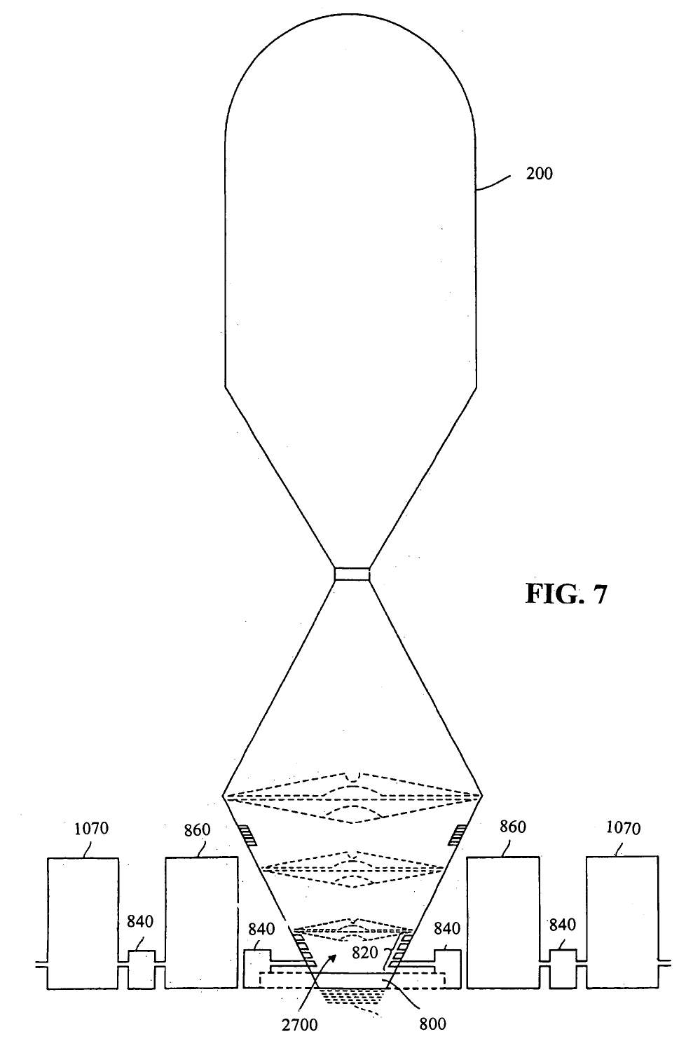

The inventive craft and propulsion sources may use a compound exhaust system as in Applicant's U.S. Pat. No. 6,367,739. The thrust generating source may use, for example, water (H₂O) and/or liquid hydrogen (H₂) as fuel. In the FIG. 7 embodiment which uses such a fuel source, the compound exhaust system 2700 may be provided with an automatic retractable air tight locking device 800 at the periphery of the exhaust chamber that will trap expanding gases. Multiple vacuum-locking doors 820 may be provided above locking device 800 around the exhaust chamber that are in communication with multiple efficient compressors 840, which are capable of sucking out the trapped gases and pumping them into multiple condensers 860 that convert the gases back to a liquid state. Thereafter, the converted liquid is pumped back to a fuel tank 1070 to be recycled and later fed to the thrust source 200. The vacuum-locking doors 820 are preferably located about one foot above the air tight locking device 800.

In operation, gases pass from the thrust source 200 through the three (or more) stages of the compound exhaust system 2700 to the exhaust chamber where the gases are contained by the locking device 800. Thereafter, the multiple vacuum-locking doors 820 may be opened to allow sucking of the gases by the multiple compressors 840 to the multiple condensers 860 where the gases are converted back to their liquid state and thereafter pumped back to the fuel tank 1070.

The locking device 800 at the periphery of the exhaust chamber may be openable to allow maintenance. The locking device 800 may also be openable to allow the superheated exiting gases to be released to the atmosphere. This may form a thick cloud of vapors, which may be a harmless byproduct or a desirable stealth mechanism that can at least partially conceal the craft.

In another embodiment, the craft can be used for interplanetary flight. The hull in such an embodiment would be designed to withstand the pressures and temperatures encountered when exiting or entering Earth's atmosphere. Additionally, the hull would be pressurized. Optionally, when traveling through space, the exhaust gases can be vented back into the craft by a vacuum system powered by compressors so that the exhaust gases can be recycled.

When used for interplanetary flight, it may be desirable to rotate the craft about its axis at a predetermined speed while in motion to create an artificial gravity. This can be achieved using the various thrust sources, by the electromagnetic plates, or other source.

In another exemplary embodiment, the inventive craft can expeditiously operate under water, similar to the craft in Applicant's U.S. Pat. No. 6,290,184. However, because of the electromagnetic hull, it has far greater capacity to dive to the deepest depths of the ocean and withstand the extreme pressures present at such depths. This is because with the craft's ability to radiate an ultra-strong electromagnetic field around its hull, it can neutralize the destructive effects of such extreme pressures by manipulating the magnetic field to magnetically curve the space along its path to keep the full force of the pressures from reaching and acting on the hull.

This invention can well be the most environmentally friendly amongst all the flying crafts of today because of its capacity to utilize water (H₂O) and/or chilled air (O₂) as fuel. It also can travel at extreme speeds, much faster than any conventional aircraft of today, and can make radar obsolete because of its capacity to radiate an ultra high frequency magnetic field around its hull and magnetically curve the space around it. This escapes the harsh effects of atmospheric pressure against its hull and repels radar signals. This invention can well become the “Ultimate Spaceship”.

While specific aspects of the invention have been described with respect to preferred embodiments of the invention, these are not intended to be limiting. Various modifications can be made without departing from the scope of the appended claims.

1. A craft, comprising:
an exterior hull defining an exterior craft surface of a predetermined surface area;
at least one propulsion source; and
an electrical generator,
wherein the hull includes a plurality of sectionalized electromagnetic plates, each of the plurality of electromagnetic plates including an outer wall and an inner wall fixedly provided on an electromagnetic core, the electromagnetic core including at least one turn of coil operatively coupled to the electrical generator to provide an electromagnetic force to each plate of a given magnitude and polarity, the electromagnetic plates collectively forming a substantial portion of the exterior craft surface to provide a controllable electromagnetic field around at least portions of the hull to magnetically curve the space adjacent the hull.

2. The craft according to claim 1, wherein the electromagnetic plates extend around the periphery of the hull of the craft.

3. The craft according to claim 1, wherein the electromagnetic plates extend radially around the hull of the craft.

4. The craft according to claim 1, wherein the electromagnetic plates are isolated from each other and are independently changeable between N and S polarity.

5. The craft according to claim 4, wherein at least one of the electromagnetic plates can be selectively adjusted to a same polarity as the Earth's closest magnetic pole.

6. The craft according to claim 1, wherein the craft is a flying craft.

7. The flying craft according to claim 6, wherein the flying craft has a saucer-shape with an upper hull portion and a lower hull portion.

8. The flying craft according to claim 7, wherein the at least one propulsion source includes a main central fixed vertical jet engine, a plurality of secondary fixed vertical jet engines provided around the periphery of the hull, at least one forward-oriented jet engine and at least one backwards-oriented jet engine.

9. The flying craft according to claim 8, further comprising a plurality of directional control nozzles around the hull.

10. The flying craft according to claim 6, wherein the flying craft has a saucer-shape with an upper hull portion and a lower hull portion, one or more sectionalized electromagnetic plates being provided on each of the upper hull portion and the lower hull portion, the collective polarity of the electromagnetic plates on the upper hull portion being the same as the collective polarity of the electromagnetic plates on the lower hull portion at least when the vehicle is hovering.

11. The craft according to claim 1, wherein the electrical generator includes at least one high frequency oscillator.

12. The craft according to claim 11, wherein the high frequency oscillator is in the form of one or more rings externally provided around the periphery of the hull.

13. The flying craft according to claim 11, wherein the high frequency oscillator is in the form of a long tube and is provided in a cavity defined between adjacent electromagnetic plates.

14. The craft according to claim 1, wherein the propulsion source is a sealed quantum jet engine having a compound exhaust system.

15. The craft according to claim 1, wherein the craft is a submersible water craft.

16. The craft according to claim 1, wherein the craft is a submersible craft.

17. A saucer-shaped flying craft, comprising:
a saucer-shaped exterior having a hull defined by an upper hull portion and a lower hull portion of predetermined surface areas;
a propulsion source including at least a main, central, fixed vertical jet engine, a plurality of secondary fixed vertical jet engines provided around the periphery of the hull, at least one forward-oriented jet engine and at least one backwards-oriented jet engine; and
an electrical generator,
wherein one or more of the upper and lower hull portions includes a plurality of sectionalized electromagnetic plates, each of the plurality of electromagnetic plates including an outer wall and an inner wall fixedly provided on an electromagnetic core, the electromagnetic core including at least one turn of coil operatively coupled to the electrical generator to provide an electromagnetic force to each plate of a given magnitude and polarity, the electromagnetic plates collectively forming a substantial portion of the exterior craft surface to provide an electromagnetic field around at least portions of the upper and/or lower hull portions to magnetically curve the space adjacent the hull.

18. The saucer-shaped flying craft according to claim 17, wherein one or more sectionalized electromagnetic plates are provided on each of the upper hull portion and the lower hull portion, and the collective polarity of the electromagnetic plates on the upper hull portion are the same as the collective polarity of the electromagnetic plates on the lower hull portion at least when the vehicle is hovering.

19. The saucer-shaped flying craft according to claim 17, wherein the electromagnetic plates extend radially around the hull of the craft.

20. The saucer-shaped flying craft according to claim 19, further comprising a cockpit located centrally on the upper hull portion, the electromagnetic plates on the upper hull portion extending from substantially a periphery of a cockpit to substantially an outer periphery of the upper hull portion.

21. The saucer-shaped flying craft according to claim 17, wherein a collective exterior surface area of the sectionalized electromagnetic plates is about one-half of the surface area of the hull.

22. The saucer-shaped flying craft according to claim 17, wherein the electrical generator includes at least one high frequency oscillator.

23. The saucer-shaped flying craft according to claim 22, wherein the high frequency oscillator is in the form of one or more rings externally provided around the periphery of the hull.

24. The saucer-shaped flying craft according to claim 22, wherein the high frequency oscillator is in the form of a long tube and is provided in a cavity defined between adjacent electromagnetic plates.

25. The saucer-shaped flying craft according to claim 17, wherein the electromagnetic plates are isolated from each other and are independently changeable between N and S polarity.

26. The saucer-shaped flying craft according to claim 25, wherein at least one of the electromagnetic plates can be selectively adjusted to a same polarity as the Earth's closest magnetic pole.

27. The saucer-shaped flying craft according to claim 16, wherein the propulsion source operates using a non-fossil fuel source.

28. A saucer-shaped flying craft, comprising:
a saucer-shaped exterior having a hull defined by an upper hull portion and a lower hull portion of predetermined surface areas, a cockpit being substantially centrally located on the upper hull portion;
a propulsion source including at least a main central fixed vertical jet engine, a plurality of secondary fixed vertical jet engines provided around the periphery of the hull, at least one forward-oriented jet engine and at least one backwards-oriented jet engine; and
an electrical generator that includes at least one ring-shaped high frequency oscillator externally provided on the periphery of the hull,
wherein at least one of the upper and lower hull portions includes a plurality of sectionalized electromagnetic plates, each of the plurality of electromagnetic plates including an outer wall and an inner wall fixedly provided on an electromagnetic core, the electromagnetic core including at least one turn of coil operatively coupled to the electrical generator to provide an electromagnetic force to each plate of a given magnitude and polarity, the electromagnetic plates extending radially on the upper hull portion from substantially the cockpit to an outer periphery of the upper hull portion, the electromagnetic plates collectively forming a substantial portion of the exterior craft surface to provide an electromagnetic field around at least portions of the upper and/or lower hull portions to magnetically curve the space adjacent the hull.
